(19) United States
(12) Patent Application Publication
(10) Pub. No.: US 2004/0203649 A1
(43) Pub. Date: Oct. 14, 2004

(54) System and method for rating communications services provisioned on demand in converging telecommunications networks

(76) Inventor: James P. Cashiola, Austin, TX (US)

Correspondence Address: Erik B. Cherdak, ERIK B. CHERDAK & ASSOCIATES, LLC, Suite 906, 11300 Rockville Pike, Rockville, MD, 20852, US

(21) Appl. No.: 10/199,502

(22) Filed: Jul. 22, 2002

(51) Int. Cl. H04Q 7/20

(52) U.S. Cl. 455/414.1; 455/423

(57) ABSTRACT

System and method for facilitating consolidated billing within a converging telecommunications network. The system and method include and involve a network resource control facility communicating with and controlling a plurality of network resources within a merged telecommunications network to deliver at least one merged communications service. Each network resource is configured to provide a communications function and to generate corresponding rating data. The network resource control facility is configured to collect the rating data from at least one network resource from the plurality of network resources in real-time related to at least one telecommunications service provided within said telecommunications network to generate rating data. The system and method further include an interface facility which is accessible via a network connection and which is configured to access the network resource control facility to receive the rating data to produce a rating report related to the telecommunications service(s) that are provided.

### BACKGROUND OF THE INVENTION

1. Field of the Invention

The present invention relates to systems and methods used to rate telecommunications services in converging telecommunications networks. More particularly, the present invention relates to systems and methods used to receive rating information from disparate telecommunications devices which may be operated by a multitude of telecommunications vendors.

2. Description of the Related Art

Today's telecommunications industry is a crowded one in which customers and service providers are being increasingly linked together via converging networks, such as in the case of converging voice and data networks. As such, a growing trend to make communications services available over publicly accessible networks such as the Internet increases the need for open, multi-vendor, multi-protocol networks and systems. Such a trend has been realized as result of the fact that service providers and others have found that closed, single-vendor, single-protocol networks are, difficult, if not impossible, to create and manage, are not scalable to meet future communications needs, and do not permit consumers to self-direct their communications needs.

As the need for more and enhanced services to be provided via the Internet increases, for example, consumers of telecommunications services will demand greater numbers of customized services, such as enhanced video-conferencing, increased bandwidth, etc. Additionally, consumers requiring greater control of their services will require the ability to self-provision and direct the provisioning of services “on demand.” Currently, providing such on-demand and often customized services and network based solutions such as those to be provided via the Internet is prohibited both in terms of capability and cost. For example, a single network solution or service (e.g., enhanced bandwidth for specific network events, etc.) now requires the concerted cooperation of several telecommunication providers and may involve the operation and control of devices manufactured and controlled by a multitude of vendors, some of which may operate based on unique and, possibly, proprietary protocols. Such disparate systems and the network resources used to deliver network services ultimately may not interface with other telecommunications devices without requiring significant effort in terms of customization and configuration. And, then, if such services can ultimately be provisioned by pre-arranging vendor relationships and pre-configuring hardware and software solutions, consumers may face costs associated with such customized services that far outweigh any benefits.

Another problem facing consumers and telecommunications providers alike, is the inability to provide rating (i.e., the rate at which specific services and/or devices are provided) information to help facilitate purchasing and supplying telecommunications services. Currently, telecommunication services are rated in advance and usually contractually. For example, long distance service may be provided to a customer of at a certain rate, such as 9 cents per minute. A long distance service provider agrees ahead of time to provide long distance at 9 cents per minute to its customers under a contract with its customers which may secure the rate and the service for a period of time, such as 6 months. Under such an agreement, a calling party's long distance calls are 9 cents per minute during the time of the contract, regardless of the actual costs of calls made (i.e., regardless of the route, devices used, etc.). Some long distance service providers will guarantee a rate on a per call basis, such as “10-10-220.” Still, other telecommunication services, such as custom services (e.g., conference calling), are provided and rated per instance of service. However, no one is providing real-time rating of telecommunication services with which a customer may monitor and potentially modify (e.g., re-routing a call via a secondary network, etc.) a telecommunication service in real-time during the delivery of the service.

Such problems are exacerbated when thought of in the context of converging networks where many different types of devices, owned and controlled by a multitude of vendors, are used across many different network layers supporting voice and data applications, and which could also be custom-linked to service a particular customer need. Rating of telecommunications services is therefore, very difficult in a converged telecommunications network because it involves receiving and processing rating information related to all such different devices, layers, vendors, etc. used to provide the telecommunications services.

Thus, there exists a need to provide new and improved systems and methods to provision network resources in converging telecommunications networks such as converging voice and data networks to deliver merged, services based on customer needs on demand, and, thus, to rate the service in real-time for the recipient. To be viable such systems and methods must support legacy systems and integrate new technologies seamlessly so that consumers of telecommunications services can obtain a breadth of feature rich services and receive rating data relating to the service being provided in real-time. Such systems and methods must support various network technologies, facilitate communications within multi-protocol networks, and permit various rating schemes. And, such new and improved systems and methods must permit consumers of telecommunications services to self-provision and self-direct their telecommunications services from within easily usable interfaces such as Internet and web based interfaces that support communications service provision on demand.

The present invention addresses the aforementioned problems and needs squarely and provides such new and improved systems and methods as described below.

### SUMMARY OF THE INVENTION

The present invention solves the aforementioned problems and provides new and improved systems and methods for integrating network resources within converging telecommunications networks to provision communications services and to consolidate billing data generated by disparate telecommunications devices. Such systems and methods are capable of enabling providers of services to link with other providers seamlessly to provide enhanced services over voice and data networks especially over publicly accessible networks such as the Internet. Consumers of telecommunications services will benefit from the present invention by obtaining greater control over their communications needs and, in particular, will gain the ability to self direct and self-provision the services they need, and the ability to receive rating data and the like.

The present invention solves the aforementioned problems and delivers the above-stated benefits by providing new and improved systems and methods for facilitating rating of services within a converging telecommunications network. The system and method include and involve a network resource control facility communicating with and controlling a plurality of network resources within a merged telecommunications network to deliver at least one merged communications service. Each network resource is configured to provide a communications function and to generate corresponding rating data. The network resource control facility is configured to receive rating data from at least one network resource from the plurality of network resources in real-time related to at least one telecommunications service provided within said telecommunications network. The system and method further include an interface facility which is accessible via a network connection and which is configured to access the network resource control facility to receive the rating data to produce a rating report related to the telecommunications service(s) that are provided.

The present invention is discussed in detail below with regard to several attached drawing figures which are next described briefly.

### BRIEF DESCRIPTION OF THE DRAWINGS FIGURES

The present invention is described in detail below with reference to the attached drawing figures, of which:

FIG. 1A is a diagram of a system in which telecommunications services may be provisioned and rated based on customer requests received in real-time and on-demand;

FIG. 1B is a diagram of a exemplary system used to deliver a service in accordance with a preferred embodiment the present invention;

FIG. 2 is a block diagram of a data processing system that may be used to implement control systems, interfacing facilities, and database management facilities in accordance with a preferred embodiment of the present invention;

FIG. 3 depicts an exemplary user interface presenting rating data designed to facilitate the provisioning telecommunication services and to monitor rating information related to the provisioned services in accordance with a preferred embodiment of the present invention; and

FIG. 4 is a flow chart that illustrates salient operations and processes that may be carried out within the system shown in FIGS. 1A and 1B to facilitate provisioning of and rating related to telecommunications services in real-time and on-demand.

### DETAILED DESCRIPTION OF THE PREFERRED EMBODIMENTS

The present invention is now discussed in detail with regard to the attached drawing figures which were briefly described above. Unless otherwise indicated, like parts and processes are referred to with like reference numerals.

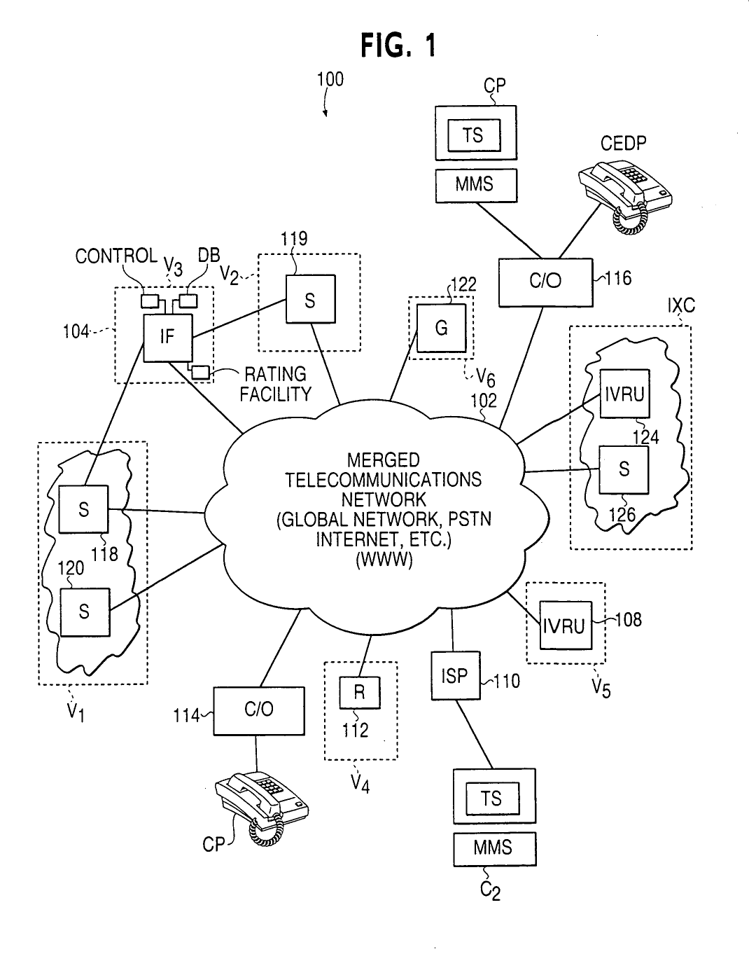

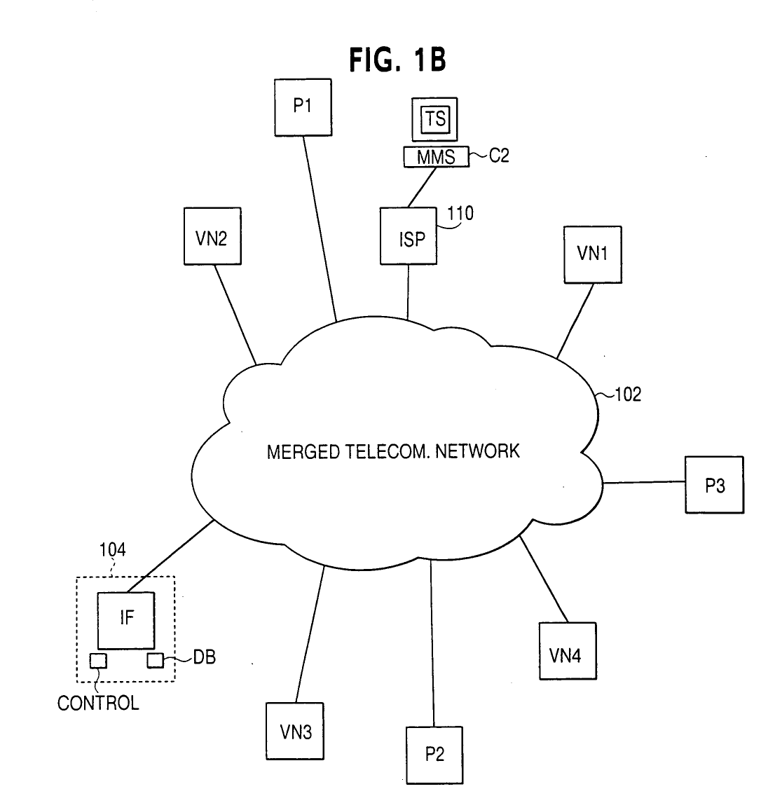

Referring now to FIG. 1A, depicted therein is a diagram of a system in which telecommunications customers may provision telecommunications services and monitor rating data related to the provisioned services in real-time and on-demand. In particular, system 100 includes a merged telecommunications network which may include at least portions of a global network, the publicly switched telephone network (PSTN), the Internet and World Wide Web (WWW), etc. Moreover, system 100 may include vendor communications systems V1 through V6 (among others), wherein each vendor system may include switching systems, interactive voice response units (IVRUs), control facilities and database management facilities, interfacing facilities and a host of other telecommunications devices found in modern telecommunications networks and which may be accessed in a merged telecommunications network 102 using a variety of modern communications protocols and device messaging schemes.

In system 100, a calling party such as calling party CP may utilize calling services through a central office 114 which is coupled to merged telecommunications network 102 to receive telecommunications services based upon communications functions provided by telecommunications devices such as those provided by vendors V1-V6. For example, a particular telecommunications service may include the operations of a router such as router 112 in the context of data based telecommunications services, voice response services, such as those provided by vendor V5 via IVRU unit 108, gateway services provided by gateway system 122 which is provided by vendor V6, etc. Moreover, telecommunications services may include voice calls which ultimately terminate at a called party such as CEDP party via central office 116. Furthermore, customer systems C1 and C2 may incorporate multimedia telecommunications systems including computing platforms that facilitate multimedia communications via merged telecommunications network 102. Such services may be provided via vendor systems V1, V3 along with an Inter-Exchange Carrier system denoted by system IXC (denoted by phantom lines forming a box around a vendor network that includes IVRU 124 and a switching platform 126).

Within system 100, vendor V3, for example, is shown to include control facilities, database management facilities DB, an interfacing facility IF and a rating facility. The control facilities in conjunction with the database management facilities DB and the interfacing facility IF, permit customers to custom configure (self-direct) telecommunications services on demand and in real time (e.g., during normal business operations) via couplings made automatically within the merged telecommunications network 102. For example, interfacing facility IF of vendor system V3 may incorporate switching facilities 118, 119, and 120 along with IVRU facilities 108 to provide a custom configured telecommunications service in real time. That is, each communications function provided by a particular telecommunications device or facility within system 100 may be treated as an inventory item within merged telecommunications network 102, for example, to facilitate custom configuration of telecommunications services on demand and based on customer requirements. Accordingly, a customer such as customer C2 may access merged telecommunications network 102 and ultimately, interfacing facility IF of vendor system V3 to custom configure bandwidth allocation services on demand and in real time without the need to request such services in advance and via live operator intervention. Accordingly, customer C2 may access an ISP system 110 to provide access to merged telecommunications network 102, for example, to engage the operations of interfacing facility IF of vendor system V3 in the abstract so that in the event that communications functions provided by disparate telecommunications devices are needed to fulfill a particular customer request, it then can be provisioned in the abstract without requiring the customer to specifically understand or be able to message to possibly disparate telecommunications devices. Furthermore, a customer requiring merged voice and data type communications services now may access a merged telecommunication network in consideration of the present invention to ultimately access IXC services, such as voice response and switching services provided IVRU facilities 124 and switching facilities 126 in combination with other services provided within merged telecommunications network 102 to provision enhanced telecommunications services on demand and in real time based upon specific customer specifications.

Additionally, the interfacing facilities provided by vendor V3, for example, permit telecommunications devices and facilities within merged telecommunications network 102 to transmit rating related to the provisioned telecommunications services to a central or otherwise consolidated data facility such as data facility 104 which includes interfacing facility IF, control facilities, rating facilities and database management facilities, and to ultimately, provide such rating data to a customer for appropriate processing thereby.

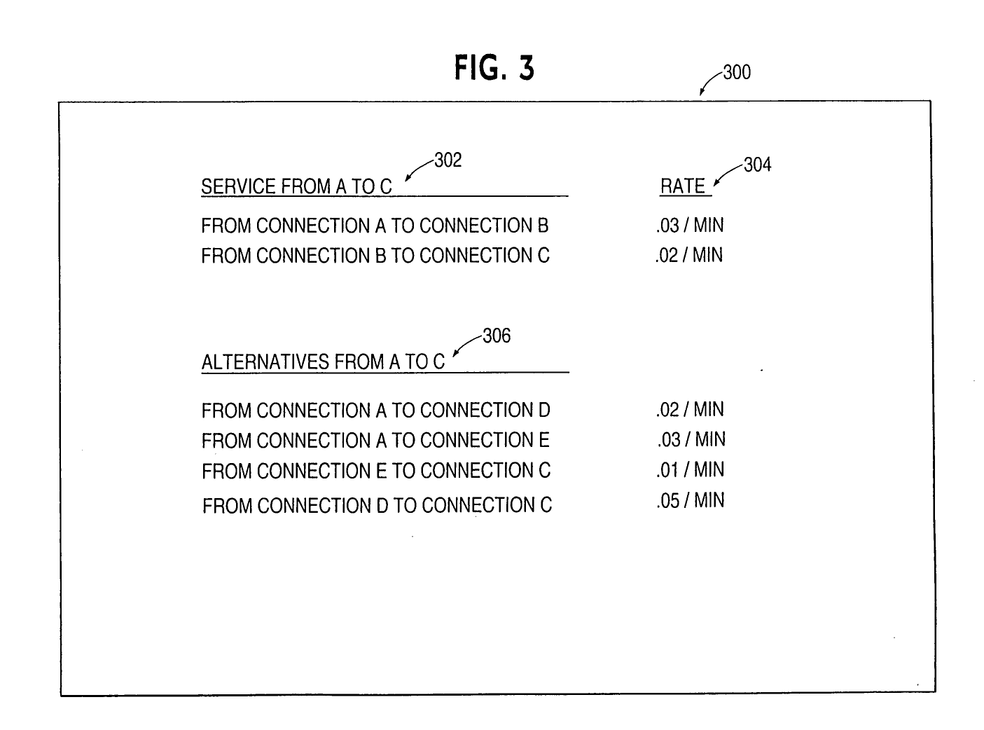

For example, referring now to FIG. 1B, a customer C2 wants to set up a video conference within merged telecommunications network 102 between three parties, P1 in England, P2 in Italy, and P3 in the United States. The customer enters the parameters necessary to provision the video conference (e.g., telephone numbers, time of call, approximate length of call, etc.) into interfacing facility IF. Interfacing facility IF is configured to provision the appropriate telecommunications devices to provide the video conference (i.e., route and terminate the calls, provide the necessary bandwidth, etc.) in accordance with the parameters entered. The provisioning of the video conference may require certain switching facilities, such as switching facility 118, and switching facility 119, to be including in the provision of that particular bandwidth telecommunications service. Accordingly, the present invention now permits switching system 118 and switching facility 119, for example, to transmit rating data in real-time to a rating facility whereby rating data generated by disparate telecommunications devices (e.g., devices communicating and messaging in accordance with disparate telecommunications protocols, etc.), communicating in accordance with disparate protocols and messaging schemes, is consolidated and provided to customer C2, possibly in a single or consolidated notice or message provided via merged telecommunication network 102. Accordingly, rating data may be collected via data facility 104 and reported to the customer via a user interface, such as the exemplary user interface depicted and described with reference to FIG. 3.

Moreover, interfacing facility IF can provision devices with in merged telecommunication network 102 that include using portions of vendor networks VN1-VN3 (e.g., networks owned by AT&T, SPRINT, MCI-WORLDCOM, etc.). Usage of each vendor network, VN1-VN3, may be rated differently (e.g., vendors may charge 1 cent per minute to use VN1, 2 cents per minute for VN2, and 3 cents per minute for VN3). Therefore, it is possible to collect rating data from the provisioned network resources including network resources within vendor networks VN1-VN3 and create a real-time tabulation of the rating of a video conference and each sub-service (e.g., carriers VN1-VN3, etc.) within the provisioned service. Moreover, there may be a fourth (or more) vendor network VN4 that may be available as an alternative route for a portion or all of the video conference call (i.e., VN4 may be available to complete a leg of the call, the entire call, or the entire call for a portion of the allotted time). To use vendor network VN4 may cost 2.5 cents per minute. Therefore, customer CP2 may want to use VN4 as an alternative to VN3 which costs 3 cents per minute to use. The present invention makes it possible for customer CP2 to monitor the real-time rating of the video conference and alternative ways to provide the service.

Furthermore, since the present invention can provision telecommunications services in real-time and monitor the rating of such provisioned telecommunications services and alternative ways to provide the provisioned telecommunications services also in real-time, the present invention makes it possible for a customer to modify the provisioning of a telecommunications service in real-time to ultimately customize the provisioned service based upon real-time rating data to receive the best service possible (i.e., most inexpensive, best networks available, etc.).

The operations of data facility 104 and interface facility IF along with control facilities and database management facilities within vendor system V3, for example, are illustrated and described in detail in co-owned, co-pending U.S. patent applications, Ser. No. 09/414,668 entitled “SYSTEM AND METHOD FOR COMMUNICATING WITH AND CONTROLLING DISPARATE TELECOMMUNICATIONS DEVICES IN A TELECOMMUNICATIONS NETWORK,” and Ser. No. 09/514,208 entitled “SYSTEM AND METHOD FOR PROVIDING COMMUNICAITON SERVICES ON DEMAND BY PROVISIONING DEVICES IN CONVERGING TELECOMMUNICATIONS NETWORKS,” as the '668 application, filed on Oct. 7, 1999, and Feb. 28, 2000, respectively, which are incorporated herein by reference. Accordingly, the reader of this patent document should refer to the aforementioned co-owned, co-pending U.S. patent application for complete disclosure details related to the operations of interfacing facility IF in the context of provisioning and providing provisioning operations based on common interfacing and messaging along with rating operations in accordance with the present invention.

The aforementioned and incorporated patent application documents and disclosures are hereby made part of this specification.

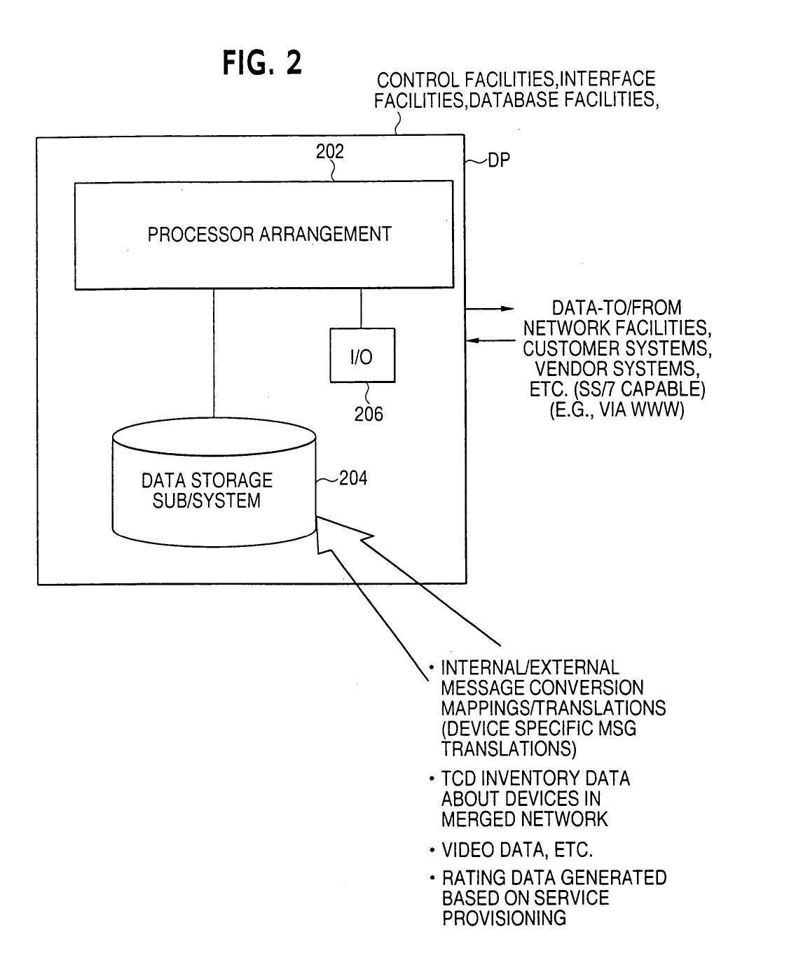

Referring now to FIG. 2, depicted therein is a block diagram of a computing system which may be used to implement control facilities, interfacing facilities, rating facilities and database management facilities as described above with regard to FIGS. 1A and 1B in accordance with a preferred embodiment of the present invention. In particular, FIG. 2 depicts a data processing system DP which further includes a processor arrangement 202 including one or more processing elements, a data storage subsystem 204, an IO facility 206. The arrangement of these structures shown with data processing system DP will be immediately understood by those skilled in the art.

Data processing system DP is configured to receive and transmit data to and from network facilities, customer systems, vendor systems, etc. via modern telecommunications protocols including, but not limited to, those used in SS7 out-of-band signaling systems, TCP/IP-protocols, H.323, IN, IP, ATM, MGCP, Parlay, and SIP communications protocols, and any other telecommunications protocols which may used to facilitate messaging between telecommunications devices in accordance with the present invention.

Data storage subsystem 204 as shown within data processing system DP, will include internal and external messaging conversion mappings and translations, which may be used to convert device specific messages (external messages) generated by specific telecommunications devices within merged telecommunications network 102 (FIG. 1) into internal messages (IMs) which are device independent which may be used to consolidate application type data to including billing operation data etc. Data storage subsystem 204 may store and provide telecommunications device (TCD) inventory data about particular telecommunication devices in merged telecommunications network 102. And, data storage subsystem 204 may include rating data generated based on service provisioning and, in particular, rating data generated by particular telecommunications devices within merged telecommunications network 102.

The structures described above with regard to FIGS. 1A, 1B and 2 are web enabled via open standards technology to support web based transactions and operations. Such operations need not involve traditional paper-based transactions and processes. The aforementioned and incorporated patent applications describe structure, processes, and methods which may be used to facilitate such web enabled functionality.

Referring now to FIG. 3, depicted therein is an exemplary user interface presenting rating data designed to facilitate the provisioning of telecommunication services and the monitor of rating information related to the provisioned services in accordance with a preferred embodiment of the present invention. In particular, screen 300 presents rating data related to a particular telecommunications service, such as the delivery of a video conference from connection point A (i.e., the PC of a party to the video conference) to connection point C (i.e., the PC of another party to the video conference). The telecommunications service is described at 302 including several legs which are each individually rated under rating 304. Here, two delivery legs are detailed, one from A to B and a second leg from B to C, and each are rated. Below, alternative ways to delivery the telecommunication service 306 are shown with their rating data so that a customer may monitor and/or modify the service during the delivery of the service. For example, two alternatives to deliver the video conference from A to C are shown. One option, from A to E then from E to C, is less costly (0.04/min. as compared to 0.05/min), and, therefore, the customer may wish to modify the delivery of the telecommunications service in order to save money. Minimal data is shown in FIG. 3, however the invention is not limited as such. More or less data may be shown as design requirements necessitate. For example, delivery legs may include portions of vendor networks, and the customer may want to know which vendor networks the telecommunications service is utilizing, etc. Also, although minutes have been shown as a unit of service, the present invention is not so limited; for example, other time periods, fixed fees, etc. may be used to price and rate calls. Alternatively, the present invention may utilize whole call/connection rating whereby a customized block unit (e.g., 11 minute blocks, etc.) may be used.

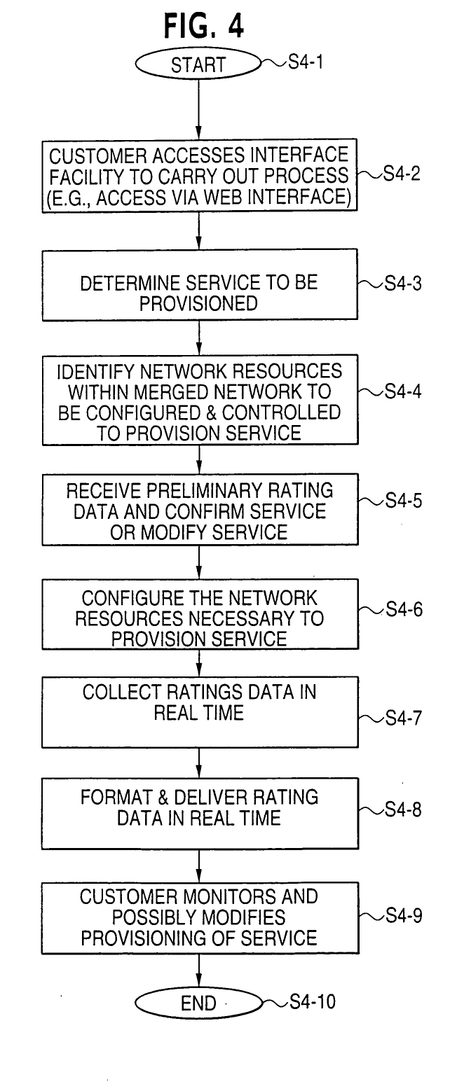

Referring now to FIG. 4, depicted therein is a flow chart that illustrates the operations that may be carried out within system 100 to facilitate the provisioning and corresponding rating operations related to such provisioning of customer configured telecommunications services provided in real-time and in accordance with a preferred embodiment of the present invention. In particular, operations begin at step S4-1 and immediately proceed to step S4-2. At step S4-2, a determination will be made as to what network/communications services are to be provided based upon customer specifications. As already described above, and in the incorporated patent references, a customer may access an interface facility, such as interface facility IF, to select the service to be provisioned.

Next, at step S4-3, the service to be provided is selected. As already described above, the appropriate parameters related to the service are entered. Processing proceeds next to step S4-4.

At step S4-4, the network resources are identified within merged network 102 necessary to provide the service selected in accordance with the parameters entered. As already explained above, interfacing facility IF along with control facilities and database facilities as shown within system 100 identify the network resources and in particular, the specific telecommunications devices within merged telecommunications network 102, to be configured and controlled to provision the services specified by the customer. Processing proceeds next to step S4-5.

At step S4-5, a preliminary collection of rating data can be performed. As already described above, interface facility IF along with control facilities, database management facilities and rating facilities are configured to access and receive rating data from disparate network resources and is also configured to store necessary rating data relating to the usage of telecommunications devices within merged network 102 in conjunction with services. Therefore, the network resources identified may be access and rating data may be received from the same relating to the selected service. Furthermore, as described above, alternative ways to provision the selected service may also be rated. The collected rating data can be provided to the customer such as done and described with reference to FIG. 3 already described above. Since the present invention provides a method for a customer to monitor rating data in real-time prior to the provisioning of a related telecommunications service, the customer is capable of confirming the method of provisioning the service automatically proposed or is capable of modifying the provisioning of the service, for example, by selected alternative delivery path, etc.

Next, at step S4-6, interfacing facilities IF along with control facilities and database facilities as shown within system 100 configure the network resources via corresponding messaging (e.g., generation of device-specific messages that are used to control and provision devices within a network system) identified in step S4-4 in real-time based on customer specifications and as confirmed or modified in step S4-5. Thus, the service is provisioned.

Next, at step S4-7, rating data is collected in real-time from the configured and controlled network resources within merged network 102 used to provision the selected service as well as from network resources within merged network 102 that may alternatively be used to provide the selected service. As already described above, rating data may relate to specific devices or to specific services or sub-services and can be collected my messaging the specific network resources configured to provide rating data, and can also be stored as inventory related to the vendor service providers.

Next, at step S4-8 the rating data collecting in step S4-7 is formatted and presented to the customer. As already described above, the rating data may be formatted in various ways, for example, as described and shown with reference to FIG. 3.

Steps S4-7 and S4-8 are intended to be repeated so as to allow a customer to continuously monitor the rating of the provisioned service throughout the entire duration of the service.

Next, at step S4-9 the customer monitors the rating data and may modify the provisioning of the selected service in real-time based on the rating data. As already described above, the customer may monitor alternative methods of delivering the selected service and may modify the delivery of the service as required.

Next, at step S4-10, the services are provisioned and processing ends.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

For instance, rating data may be collected in real-time and sent to a customer in any form (hard copy, email, etc.) after the provisioning of the service. Additionally, rating data related to static or fixed fee services may be store locally in data facility 104 and updated by vendors as rates change. Moreover, the format and delivery of rating data may vary according to customer and/or vendor requirements.

What is claimed is:

1. A system for facilitating rating a provisioned telecommunication service within a converging telecommunications network, comprising:
a network resource control facility communicating with and controlling a plurality of network resources within a merged telecommunications network to deliver at least one merged telecommunication service, each network resource of said plurality of network resources configured to provide a communications function and to generate corresponding rating data, said network resource control facility configured to receive said rating data from at least one network resource from said plurality of network resources in real-time related to at least one telecommunications service provided within said telecommunications network; and
an interface facility accessible via a network connection and configured to access said network resource control facility to receive said rating data to report said rating data related to said at least one telecommunications service.

2. The system according to claim 1, wherein said communications service includes dynamic allocation of bandwidth provided by said at least one network resource, said rating data including rating data related to bandwidth allocation.

3. The system according to claim 1, wherein said communications services includes voice and data network resources from said plurality of network resources, said rating data including rating data related to voice and data communication functions.

4. The system according to claim 1, wherein said interface facility permits access to said network resource control facility via the Internet.

5. The system according to claim 4, wherein said interface facility permits access via the World Wide Web.

6. The system according to claim 1, wherein said network resource control facility communicates with said plurality of network resources using a standard communications protocol.

7. The system according to claim 6, wherein said standard communications protocol is the H.323 protocol.

8. The system according to claim 1, wherein said plurality of network resources are switches, routers, gatekeepers, servers, and interactive voice response units (IVRU).

9. The system according to claim 1, wherein said consolidated rating data includes references to rating data provided by at least one telecommunications provider based on allocation of said at least one network resource.

10. The system according to claim 1, wherein said consolidated rating data is available via said telecommunications network in real-time.

11. The system according to claim 1, wherein said rating data is accessible via the Internet in real time and during the provisioning of said at least one telecommunications service.

12. A system for provisioning on-demand communications services and for consolidating rating data related to said services, comprising:
a network management facility communicating with and controlling disparate telecommunications devices within a telecommunications network, wherein said network management facility automatically configures and controls said disparate telecommunications devices within said network in real-time;
a database facility storing inventory data related to said disparate telecommunications devices within said network, said database facility also storing rating data generated by each of said disparate telecommunications devices; and
an interface accessible via a network connection, coupled to said database facility and configured to access said network management facility via said network and to provision at least one of said disparate telecommunications devices to provide at least one communication service on-demand and in real-time based upon corresponding inventory data stored by said database facility, and to access said database facility to report rating data related to said at least one communication service in real-time.

13. The system according to claim 12, wherein said database maintains address, communication protocol, manufacturer and vendor information corresponding to said disparate telecommunications devices within said network.

14. The system according to claim 12, wherein said communication service includes bandwidth allocation to an Internet customer.

15. The system according to claim 12, wherein said interface is further configured to access said network management facility and to provision said network in order to monitor and route traffic though said network.

16. The system according to claim 12, wherein said interface is further configured to access said network management facility and to provision said network in real-time.

17. The system according to claim 12, wherein said network management facility communicates with said disparate telecommunications devices using a standard communications protocol.

18. The system according to claim 15, wherein said standard communications protocol is the H.323 protocol.

19. The system according to claim 12, wherein said disparate telecommunications devices include switches, routers, gatekeepers, servers, and interactive voice response units (IVRU).

20. The system according to claim 12, wherein said rating data is made available to a customer via the Internet.

21. The system according to claim 12, wherein said rating data includes rating data generated by a plurality of telecommunications devices based on said at least one communications service.

22. The system according to claim 12, wherein said rating data includes references to rating data provided by at least one telecommunications provider corresponding to said at least one telecommunications device.

23. The system according to claim 12, wherein said rating data is accessible via said telecommunications network in real time.

24. The system according to claim 1, wherein said rating report is accessible via the Internet in real time and during the provisioning of said at least one communications service.

25. A method for self-provisioning and rating for communications services within a merged telecommunications network, comprising the steps of:
determining a communications service to be provided;
automatically identifying network resources within a merged telecommunications network to be configured and controlled to provide said communications service;
automatically configuring said network resources in real-time to provide said communications service;
collecting rating data generated by each network resource configured to provide said communications service; and
generating a rating report data based on said rating data generated by each network resource configured to provide said communications service.

26. The method according to claim 25, further comprising the step of storing said rating data to be accessible via said telecommunications network.

27. The method according to claim 25, further comprising the step of storing said rating data to be accessible via the Internet.

28. The method according to claim 25, wherein said rating data includes data generated by at least one service provider in real time and during the provision of said communications service.

29. The method according to claim 25, further comprising the steps of:
accessing an interfacing facility to determine said network resource to be provided during said determining step; and
permitting a customer to carry out said accessing step.
